(19) United States
(12) Patent Application Publication
(10) Pub. No.: US 2006/0176158 A1
(43) Pub. Date: Aug. 10, 2006

(54) Energy harvesting vehicle condition sensing system

(75) Inventor: William J. Fleming, Rochester, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Vehicle Safety Systems Inc.

(21) Appl. No.: 11/044,608

(22) Filed: Jan. 27, 2005

(51) Int. Cl. B60Q 1/00; E05F 15/00; G08B 23/00

(52) U.S. Cl. 340/425.5; 340/693.1; 701/45

(57) ABSTRACT

A system (10) includes an electrical sensor (14) for sensing a condition of a vehicle (12). The system (10) also includes an energy harvesting device (50) for providing electrical energy in response to the vehicle environment. The electrical energy is provided to the electrical sensor (14). The system (10) further includes a device (34) on the vehicle (12) actuatable in response to the condition of the vehicle sensed by the sensor (14). The device (34) is an inflator (132, 142, 152) for an inflatable vehicle occupant protection device (130, 140, 150), a seat belt pretensioner (112), a vehicle chassis control device (430, 432), a steering power assist device (410), indicator lights (424), gauges (426), a vehicle security system (610), a vehicle HVAC system (620), a rear view mirror anti-glare system (630), or a wiper control system (602).

### TECHNICAL FIELD

The present invention relates to a system for sensing conditions in a vehicle. More particularly, the present invention relates to a vehicle condition sensing system that includes an energy harvesting power source.

### BACKGROUND OF THE INVENTION

It is known to provide sensors for sensing conditions in a vehicle. These vehicle condition sensors may include, for example, vehicle impact sensors, rollover sensors, seat position sensors, seat weight sensors, seatbelt latch sensors, seatbelt tension sensors, occupant position sensors, shaft torque sensors, steering wheel position sensors, fuel level sensors, engine condition sensors, and chassis condition sensors. Many of these vehicle condition sensors are mounted on vehicle parts that are movable relative to the remainder of the vehicle.

Vehicle condition sensors may provide information used to help control operation of various vehicle systems. For example, the operation of vehicle occupant protection devices, such as air bags, inflatable curtains, and seatbelt pretensioners, may be tailored according to information provided by seatbelt latch sensors, seatbelt tension sensors, seat position sensors, seat weight sensors, occupant position sensors, vehicle acceleration sensors, or a combination of such sensors. For instance, it is known to vary the pressure to which an inflatable vehicle occupant protection device is inflated according to factors such as crash severity, occupant size, occupant weight, and occupant position.

### SUMMARY OF THE INVENTION

The present invention relates to a system that includes an electrical sensor for sensing a condition of a vehicle. The system also includes an energy harvesting device for providing electrical energy in response to the vehicle environment. The electrical energy is provided to the electrical sensor. The system further includes a device on the vehicle actuatable in response to the condition of the vehicle sensed by the sensor. The device is an inflator for an inflatable vehicle occupant protection device, a seat belt pretensioner, a vehicle chassis control device, a steering power assist device, indicator lights, gauges, a vehicle security system, a vehicle HVAC system, a rear view mirror anti-glare system, or a wiper control system.

The present invention also relates to a system including an electrical sensor for sensing a condition of a vehicle. The system also includes an energy harvesting device for providing electrical energy in response to the vehicle environment. The electrical energy is provided to said electrical sensor. The system further includes a device on the vehicle actuatable in response to the condition of the vehicle sensed by the sensor. The energy harvesting device responds to solar or thermal energy of the vehicle environment.

The present invention further relates to a system for protecting an occupant of a vehicle. The system includes an actuatable vehicle occupant protection device. The system also includes an electrical sensor for sensing a condition of a vehicle. The system also includes control means for controlling actuation of the vehicle occupant protection device in response to the condition of the vehicle sensed by the sensor. The system further includes an energy harvesting device for providing electrical energy in response to the vehicle environment. The electrical energy is provided to the electrical sensor to power the electrical sensor.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a block diagram illustrating an energy harvesting vehicle condition sensing system, according to the present invention;

FIG. 2A is a schematic view of a vehicle illustrating various implementations of the energy harvesting vehicle condition sensing system of FIG. 1;

FIGS. 2B-2J are schematic views of systems implemented in the vehicle of FIG. 2A;

FIG. 3A is a schematic view of a vehicle illustrating other implementations of the energy harvesting vehicle condition sensing system of FIG. 1;

FIGS. 3B-3H are schematic views of systems implemented in the vehicle of FIG. 3A;

FIG. 4A is a schematic view of a vehicle illustrating further implementations of the energy harvesting vehicle condition sensing system of FIG. 1; and

FIGS. 4B-4E are schematic views of systems implemented in the vehicle of FIG. 4A.

### DESCRIPTION OF EMBODIMENTS OF THE INVENTION

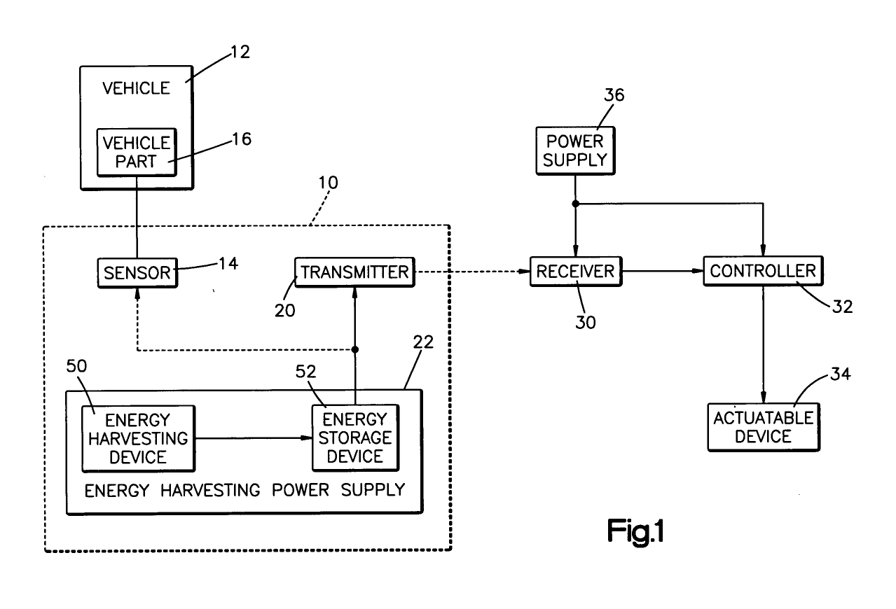

As representative of the present invention, FIG. 1 illustrates schematically a system 10 for sensing a condition of a vehicle 12. The system 10 includes a sensor 14 that is operatively connected to a part 16 of the vehicle 12. The sensor 14 is operative to monitor conditions, such as a condition of the vehicle 12, a condition of the vehicle part 16, or a condition of an environment of the vehicle 12.

The system 10 also includes a transmitter 20 operatively connected to the sensor 14. The transmitter 20 is operative to provide a wireless signal related to the condition sensed by the sensor 14. This wireless signal may, for example, be an electromagnetic signal, such as a radio frequency (RF) signal. The system 10 also includes a power supply 22 for providing electrical power to the sensor 14, transmitter 20, or both.

A receiver 30 receives the wireless signal transmitted by the transmitter 20. The receiver 30 is operatively connected to a controller 32, which is operatively connected to an actuatable device 34 of the vehicle 12. The controller 32 may, for example, comprise a microcomputer, discrete circuit, or an integrated circuit. A power supply 36 supplies electrical power to the receiver 30 and controller 32. The power supply 36 may, for example, comprise a vehicle battery, a separate dedicated battery, or another suitable source of electrical power.

According to the present invention, the power supply 22 of the system 10 is an energy harvesting power supply. The power supply 22 includes an energy harvesting device 50 and an energy storage device 52 for storing electrical energy produced by the energy harvesting device. The energy storage device 52 may, for example, be a capacitive storage device, such as a capacitor. The power supply 22 may also include additional devices (not shown), such as power conditioning devices or power regulating devices.

The energy harvesting device 50 produces electrical energy by converting other energy forms harvested from the vehicle environment to which the energy harvesting device is exposed. According to the present invention, the energy harvesting device 50 may harvest vibratory energy, strain energy, solar energy, or thermal energy. The type of energy harvesting device 50 used in a particular system 10 thus depends on the vehicle environment in which the system is implemented.

An energy harvesting device 50 for harvesting vibratory energy, strain energy, or both may comprise a piezoelectric material, a piezoresistive material, or both. Piezoelectric materials have the ability to generate a voltage when mechanical force is applied to the material. Piezoresistive materials have a resistance that varies when mechanical force is applied to the material. Piezoelectric and piezoresistive materials are known in the art and may include, for example, certain crystals and ceramics.

According to one embodiment of the present invention, the energy harvesting device 50 may comprise a piezoelectric material for converting vehicle vibrations, strain on vehicle components, or both to electrical energy. According to another embodiment of the present invention, the energy harvesting device 50 may comprise a thermoelectric material for converting heat energy into electrical energy. According to another embodiment of the present invention, the energy harvesting device 50 may comprise a photovoltaic material for converting light or solar energy into electrical energy.

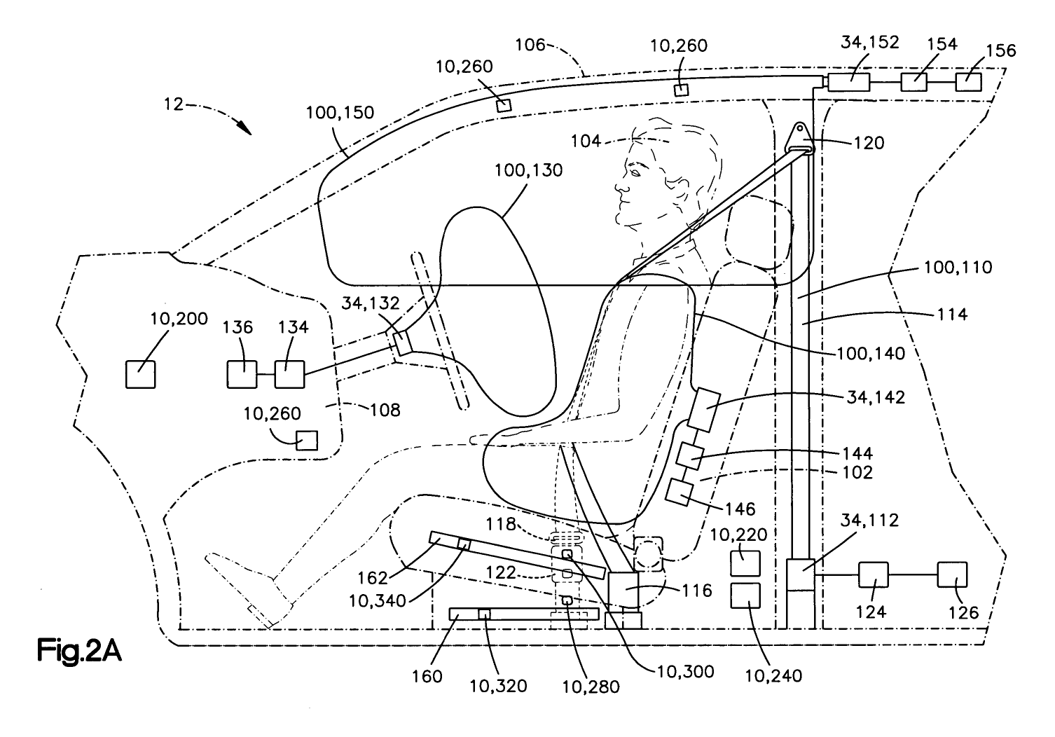

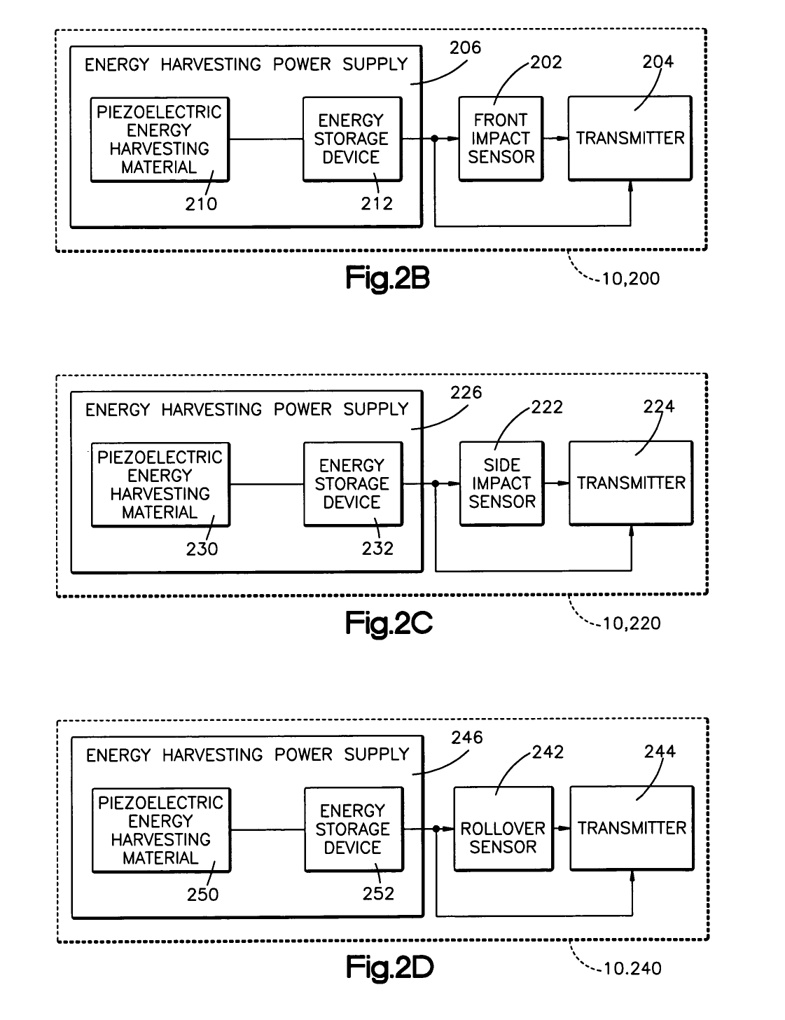

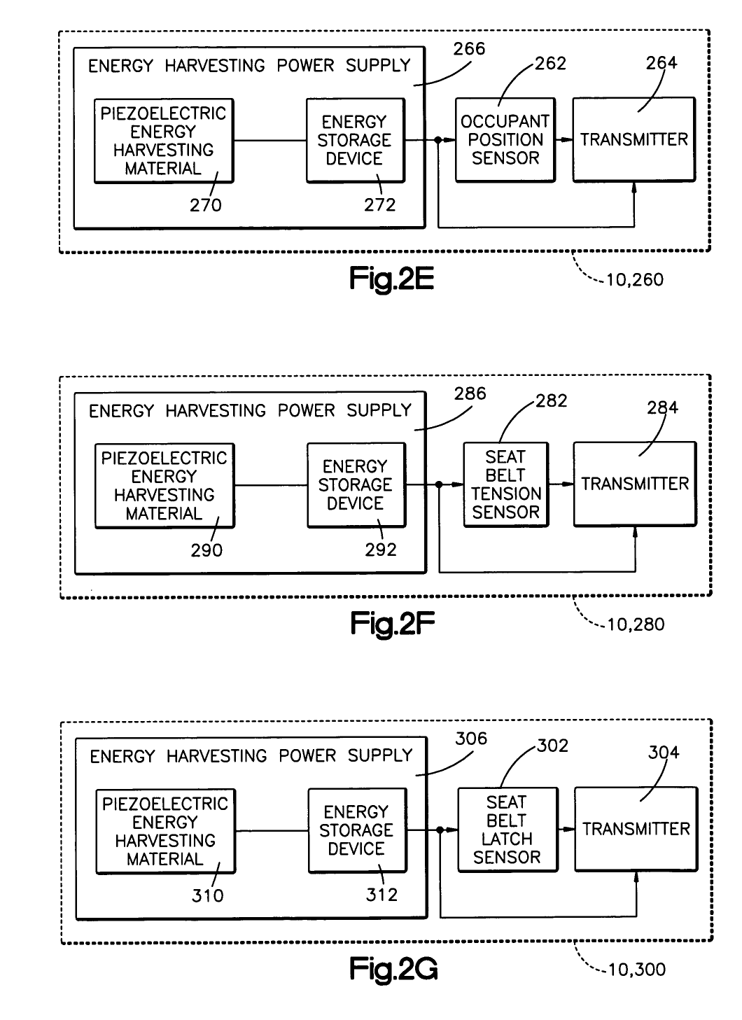

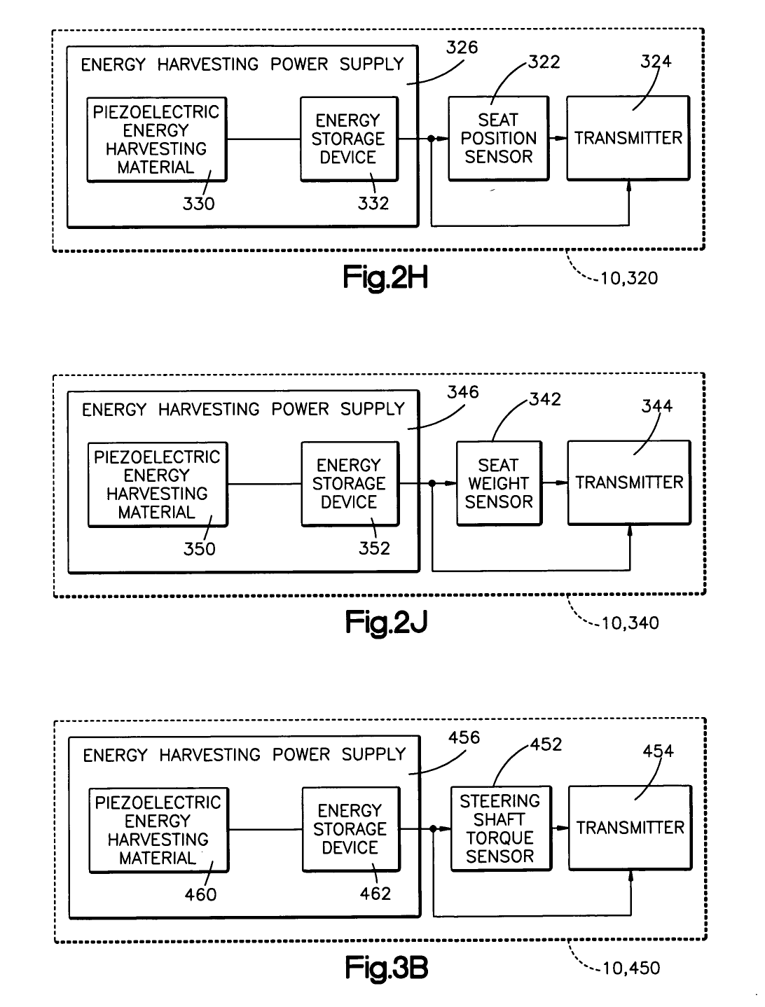

Referring to FIG. 2A, the vehicle 12 may include vehicle occupant protection devices 100 in the form of a seat belt 110, a front impact air bag 130, a side impact air bag 140, and an inflatable curtain 150. An actuatable device 34 associated with the seat belt 110 may be a pretensioner 112. An actuatable device 34 associated with the front impact air bag 130 may be an inflator 132. An actuatable device 34 associated with the side impact air bag 140 may be an inflator 142. An actuatable device 34 associated with the side curtain 150 may be an inflator 152.

The seat belt 110 includes a length of webbing 114 that has a first end connected to the vehicle 12 by an anchor 116 connected to the vehicle on an outboard side of vehicle seat 102. The webbing 114 has an opposite end connected to the vehicle by the pretensioner 112. The webbing 114 extends through a tongue 118 and a guide 120, which is connected to the vehicle 12. A seat belt buckle 122 is secured to the vehicle 12 on an inboard side of the vehicle seat 102, opposite the anchor 116. The tongue 118 is insertable into the buckle 122 to releasably latch the tongue in the buckle.

When the tongue 118 is latched in the buckle 122, a portion of the webbing 114 between the tongue 118 and the anchor 116 extends across a lap of an occupant 104 of the seat 102. Also, when the tongue 118 is latched in the buckle 122, a portion of the webbing 114 between the tongue 118 and the guide 120 extends across a torso and over an outboard shoulder of the occupant 104 of the seat 102. The seat belt 110 may thus help protect the occupant 104 by restraining the occupant in the seat 102.

As shown in FIG. 2A, the vehicle 12 may include several systems 10 for sensing condition(s) of the vehicle. The systems 10 may include a front impact sensing system 200, a side impact sensing system 220, a rollover sensing system 240, occupant position sensing system(s) 260, a seat belt tension sensing system 280, a seat belt buckle latch sensing system 300, a seat position sensing system 320, and a seat weight sensing system 340. As described below, individual systems 10 or combinations of such systems may provide information used to help control actuation of the vehicle occupant protection devices 100.

The systems 10 implemented in the vehicle 12 of FIG. 2A are illustrated in FIGS. 2B-2J. Referring to FIG. 2B, the front impact sensing system 200 includes a front impact sensor 202. The front impact sensor 202 is a known device that may, for example, comprise an accelerometer. The front impact sensor 202 is operative to sense the occurrence of a front impact to the vehicle 12. The front impact sensor 202 is operatively connected to a transmitter 204 that provides a wireless signal related to the front impact condition sensed by the front impact sensor 202. The system 200 also includes an energy harvesting power supply 206.

The energy harvesting power supply 206 includes a piezoelectric energy harvesting material 210 and an energy storage device 212. The piezoelectric energy harvesting material 210 generates electrical energy, which is supplied to the energy storage device 212. The energy storage device 212 supplies electrical energy to the front impact sensor 202 and transmitter 204.

The front impact sensing system 200 is connected to a vehicle part 16 (see FIG. 1), such as a vehicle frame (not shown). The connection is done in a manner such that the piezoelectric energy harvesting material 210 vibrates with the vehicle part 16. For example, the piezoelectric energy harvesting material 210 may be bonded to a substrate, which is bonded to the vehicle part 16. Thus, the piezoelectric energy harvesting material 210 generates electrical energy in response to vibrations experienced during operation of the vehicle 12. This electrical energy powers the front impact sensor 202 and transmitter 204. The front impact sensing system 200 may thus function without requiring any batteries or external wiring.

Referring to FIG. 2C, the side impact sensing system 220 includes a side impact sensor 222. The side impact sensor 222 is a known device that may, for example, comprise an accelerometer. The side impact sensor 222 is operative to sense the occurrence of a side impact to the vehicle 12. The side impact sensor 222 is operatively connected to a transmitter 224 that provides a wireless signal related to the side impact condition sensed by the side impact sensor 222. The system 220 also includes an energy harvesting power supply 226.

The energy harvesting power supply 226 includes a piezoelectric energy harvesting material 230 and an energy storage device 232. The piezoelectric energy harvesting material 230 generates electrical energy, which is supplied to the energy storage device 232. The energy storage device 232 supplies electrical energy to the side impact sensor 222 and transmitter 224.

The side impact sensing system 220 is connected to a vehicle part 16 (see FIG. 1), such as a vehicle frame (not shown). The connection is done in a manner such that the piezoelectric energy harvesting material 230 vibrates with the vehicle part 16. The piezoelectric energy harvesting material 230 generates electrical energy in response to vibrations experienced during operation of the vehicle 12. This electrical energy powers the side impact sensor 222 and transmitter 224. The side impact sensing system 220 may thus function without requiring any batteries or external wiring.

Referring to FIG. 2D, the rollover sensing system 240 includes a rollover sensor 242. The rollover sensor 242 is a known device that may, for example, comprise an accelerometer. The rollover sensor 242 is operative to sense the occurrence of a rollover of the vehicle 12. The rollover sensor 242 is operatively connected to a transmitter 244 that provides a wireless signal related to the rollover condition sensed by the rollover sensor 242. The system 240 also includes an energy harvesting power supply 246.

The energy harvesting power supply 246 includes a piezoelectric energy harvesting material 250 and an energy storage device 252. The piezoelectric energy harvesting material 250 generates electrical energy, which is supplied to the energy storage device 252. The energy storage device 252 supplies electrical energy to the rollover sensor 242 and transmitter 244.

The rollover sensing system 240 is connected to a vehicle part 16 (see FIG. 1), such as a vehicle frame (not shown). The connection is done in a manner such that the piezoelectric energy harvesting material 250 vibrates with the vehicle part 16. The piezoelectric energy harvesting material 250 generates electrical energy in response to vibrations experienced during operation of the vehicle 12. This electrical energy powers the rollover sensor 242 and transmitter 244. The rollover sensing system 240 may thus function without requiring any batteries or external wiring.

Referring to FIG. 2E, the occupant position sensing system 260 includes a occupant position sensor 262. The occupant position sensor 262 is a known device that may, for example, comprise an ultrasonic transducer. The occupant position sensor 262 is operative to sense the position of an occupant 104 (see FIG. 2A) of the vehicle 12. The occupant position sensor 262 is operatively connected to a transmitter 264 that provides a wireless signal related to the occupant position sensed by the occupant position sensor 262. The system 260 also includes an energy harvesting power supply 266.

The energy harvesting power supply 266 includes a piezoelectric energy harvesting material 270 and an energy storage device 272. The piezoelectric energy harvesting material 270 generates electrical energy, which is supplied to the energy storage device 272. The energy storage device 272 supplies electrical energy to the occupant position sensor 262 and transmitter 264.

The occupant position sensing system 260 is connected to a vehicle part 16 (see FIG. 1), such as a vehicle roof 106 (FIG. 2A) or instrument panel 108. The connection is done in a manner such that the piezoelectric energy harvesting material 270 vibrates with the vehicle part 16. The piezoelectric energy harvesting material 270 generates electrical energy in response to vibrations experienced during operation of the vehicle 12. This electrical energy powers the occupant position sensor 262 and transmitter 264. The occupant position sensing system 260 may thus function without requiring any batteries or external wiring.

Referring to FIG. 2F, the seat belt tension sensing system 280 includes a seat belt tension sensor 282. The seat belt tension sensor 282 is a known device that may, for example, comprise a strain gauge. The seat belt tension sensor 282 is operative to sense the amount of tension on the seat belt 110 (see FIG. 2A) of the vehicle 12. The seat belt tension sensor 282 is operatively connected to a transmitter 284 that provides a wireless signal related to the seat belt tension sensed by the seat belt tension sensor 282. The system 280 also includes an energy harvesting power supply 286.

The energy harvesting power supply 286 includes a piezoelectric energy harvesting material 290 and an energy storage device 292. The piezoelectric energy harvesting material 290 generates electrical energy, which is supplied to the energy storage device 292. The energy storage device 292 supplies electrical energy to the seat belt tension sensor 282 and transmitter 284.

The seat belt tension sensing system 280 is connected to a vehicle part 16 (see FIG. 1), such as the seat belt buckle 122 (FIG. 2A). The connection is done in a manner such that the piezoelectric energy harvesting material 290 vibrates with the vehicle part 16. The piezoelectric energy harvesting material 290 generates electrical energy in response to vibrations experienced during operation of the vehicle 12. This electrical energy powers the seat belt tension sensor 282 and transmitter 284. The seat belt tension sensing system 280 may thus function without requiring any batteries or external wiring.

Referring to FIG. 2G, the seat belt buckle latch sensing system 300 includes a seat belt buckle latch sensor 302. The seat belt buckle latch sensor 302 is a known device that may, for example, comprise a Hall effect sensor. The seat belt buckle latch sensor 302 is operative to sense whether the seat belt tongue 118 (see FIG. 2A) is latched in the seat belt buckle 122. The seat belt buckle latch sensor 302 is operatively connected to a transmitter 304 that provides a wireless signal related to the latched or unlatched condition of the seat belt buckle latch sensed by the seat belt buckle latch sensor 302. The system 300 also includes an energy harvesting power supply 306.

The energy harvesting power supply 306 includes a piezoelectric energy harvesting material 310 and an energy storage device 312. The piezoelectric energy harvesting material 310 generates electrical energy, which is supplied to the energy storage device 312. The energy storage device 312 supplies electrical energy to the seat belt buckle latch sensor 302 and transmitter 304.

The seat belt buckle latch sensing system 300 is connected to a vehicle part 16 (see FIG. 1), particularly the seat belt buckle 122 (FIG. 2A). The connection is done in a manner such that the piezoelectric energy harvesting material 310 vibrates with the vehicle part 16. The piezoelectric energy harvesting material 310 generates electrical energy in response to vibrations experienced during operation of the vehicle 12. The piezoelectric energy harvesting material 310 may also generate electrical energy in response to undergoing vibrations or strains in response to latching and un-latching the seat belt buckle 122. This electrical energy powers the seat belt buckle latch sensor 302 and transmitter 304. The seat belt buckle latch sensing system 300 may thus function without requiring any batteries or external wiring.

Referring to FIG. 2H, the seat position sensing system 320 includes a seat position sensor 322. The seat position sensor 322 is a known device that may, for example, comprise a Hall effect sensor. The seat position sensor 322 is operative to sense the position of the seat 102 (see FIG. 2A) in the vehicle 12. The seat position sensor 322 is operatively connected to a transmitter 324 that provides a wireless signal related to the seat position sensed by the seat position sensor 322. The system 320 also includes an energy harvesting power supply 326.

The energy harvesting power supply 326 includes a piezoelectric energy harvesting material 330 and an energy storage device 332. The piezoelectric energy harvesting material 330 generates electrical energy, which is supplied to the energy storage device 332. The energy storage device 332 supplies electrical energy to the seat position sensor 322 and transmitter 324.

The seat position sensing system 320 is connected to a vehicle part 16 (see FIG. 1), such as a seat mounting rail 160 (FIG. 2A). The connection is done in a manner such that the piezoelectric energy harvesting material 330 vibrates with the vehicle part 16. The piezoelectric energy harvesting material 330 generates electrical energy in response to vibrations experienced during operation of the vehicle 12. The piezoelectric energy harvesting material 330 may also generate electrical energy in response to undergoing vibrations or strains in response to adjusting the position of the vehicle seat 102. This electrical energy powers the seat position sensor 322 and transmitter 324. The seat position sensing system 320 may thus function without requiring any batteries or external wiring.

Referring to FIG. 2J, the seat weight sensing system 340 includes a seat weight sensor 342. The seat weight sensor 342 is a known device that may, for example, comprise a strain gauge. The seat weight sensor 342 is operative to sense the weight supported by the seat 102 (see FIG. 2A) in the vehicle 12. The seat weight sensor 342 is operatively connected to a transmitter 344 that provides a wireless signal related to the seat weight sensed by the seat weight sensor 342. The system 340 also includes an energy harvesting power supply 346.

The energy harvesting power supply 346 includes a piezoelectric energy harvesting material 350 and an energy storage device 352. The piezoelectric energy harvesting material 350 generates electrical energy, which is supplied to the energy storage device 352. The energy storage device 352 supplies electrical energy to the seat weight sensor 342 and transmitter 344.

The seat weight sensing system 340 is connected to a vehicle part 16 (see FIG. 1), such as a seat frame member 162 (FIG. 2A). The connection is done in a manner such that the piezoelectric energy harvesting material 350 vibrates with the vehicle part 16. The piezoelectric energy harvesting material 350 generates electrical energy in response to vibrations experienced during operation of the vehicle 12. The piezoelectric energy harvesting material 350 may also generate electrical energy in response to undergoing vibrations or strains in response to loading the seat 102, unloading the seat, or movement on the seat. This electrical energy powers the seat weight sensor 342 and transmitter 344. The seat weight sensing system 340 may thus function without requiring any batteries or external wiring.

The seat belt pretensioner 112 is associated with a controller 124, which is associated with a receiver 126. The receiver 126 is operable to receive wireless signals from the various sensing systems 10 of the vehicle. The controller 124 is operable to actuate the seat belt pretensioner 112 in response to the wireless signals received by the receiver 126. For example, the controller 124 may be operable to actuate the seat belt pretensioner 112 in response to wireless signals received from the front impact sensing system 200, the side impact sensing system 220, the rollover sensing system 240, the occupant position sensing system 260, the seat belt tension sensing system 280, the seat belt buckle latch sensing system 300, the seat position sensing system 320, the seat weight sensing system 340, or a combination of such systems.

The inflator 132 for the front impact air bag 130 is associated with a controller 134, which is associated with a receiver 136. The receiver 136 is operable to receive wireless signals from the various sensing systems 10 of the vehicle. The controller 134 is operable to actuate the inflator 132 in response to the wireless signals received by the receiver 136. For example, the controller 134 may be operable to actuate the inflator 132 in response to wireless signals received from the front impact sensing system 200, the occupant position sensing system 260, the seat belt tension sensing system 280, the seat belt buckle latch sensing system 300, the seat position sensing system 320, the seat weight sensing system 340, or a combination of such systems.

The inflator 142 for the side impact air bag 140 is associated with a controller 144, which is associated with a receiver 146. The receiver 146 is operable to receive wireless signals from the various sensing systems 10 of the vehicle. The controller 144 is operable to actuate the inflator 142 in response to the wireless signals received by the receiver 146. For example, the controller 144 may be operable to actuate the inflator 142 in response to wireless signals received from the side impact sensing system 220, the rollover sensing system 240, or both.

The inflator 152 for the side curtain 150 is associated with a controller 154, which is associated with a receiver 156. The receiver 156 is operable to receive wireless signals from the various sensing systems 10 of the vehicle. The controller 154 is operable to actuate the inflator 152 in response to the wireless signals received by the receiver 156. For example, the controller 154 may be operable to actuate the inflator 152 in response to wireless signals received from the side impact sensing system 220, the rollover sensing system 240, or both.

In view of the foregoing, it will be appreciated that the systems 10 for sensing conditions of the vehicle 12 provide wireless signals indicative of sensed vehicle conditions for helping to control the actuation of the vehicle occupant protection devices 100. The systems 10 are self-powered via energy harvesting devices and thus are battery-free and do not require any external wiring. The systems 10 may thus be installed in the vehicle 12 without having concerns over wiring routes and vehicle wiring harnesses.

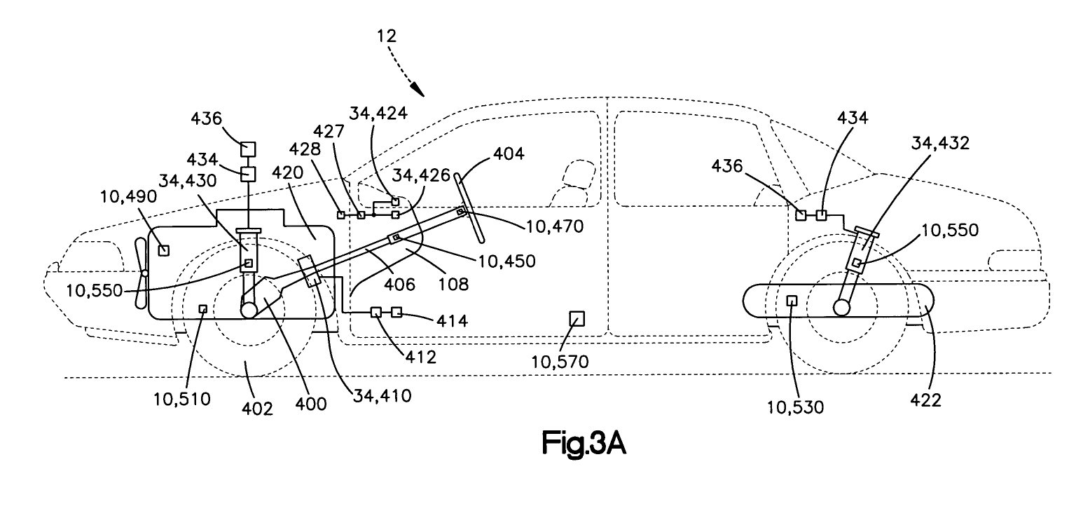

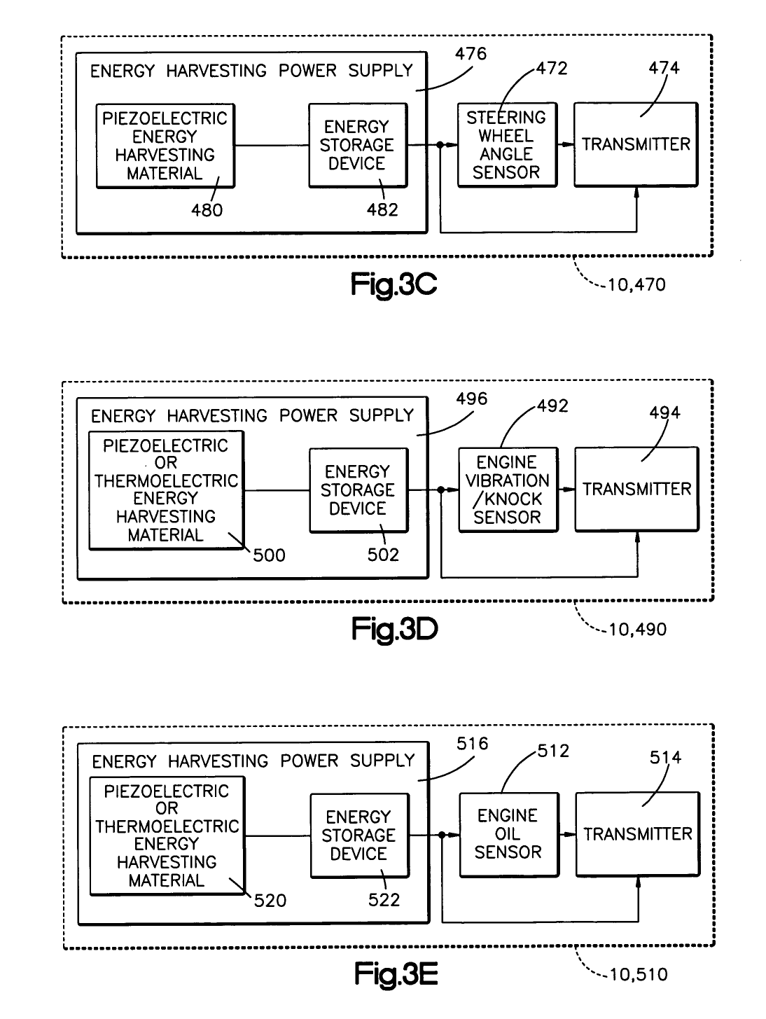

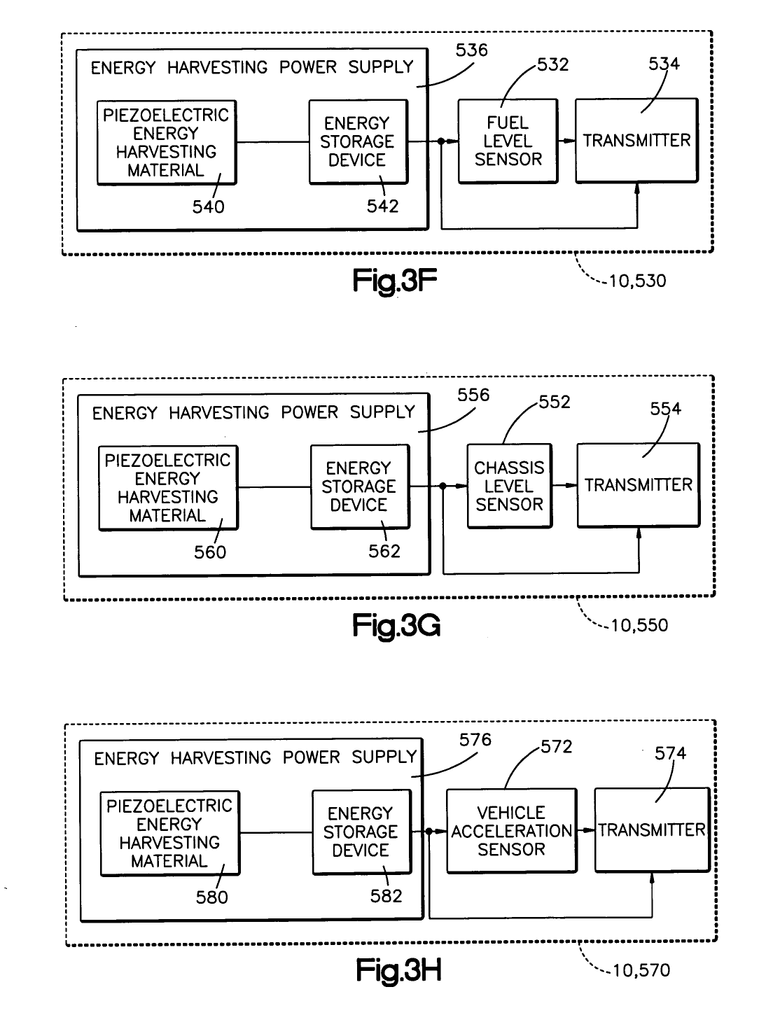

Referring to FIG. 3A, the vehicle 12 may include a steering gear 400 for effecting steering movement of steerable wheels 402 of the vehicle. The steering gear 400 may be linked to a steering wheel 404 of the vehicle 12 by a steering shaft 406. The steering gear 400 may include an actuatable device 34 in the form of a power assist device 410 for assisting the steering movement of the wheels 402. For example, the steering gear may include power assist means in the form of a known hydraulic assist power steering system or a known electric assist power steering system.

The vehicle 12 also includes an engine 420 and a fuel tank 422 for storing fuel for fueling the engine. Actuatable devices 34 related to the engine 420 and fuel tank 422 may include indicator lights 424 or gauges 426 on the instrument panel 108 of the vehicle 12. The indicator lights 424 may indicate sensed events, such as engine trouble, low engine oil pressure, low engine oil level, or high engine oil temperature. The gauges 426 may indicate sensed conditions of the engine 320, such as engine oil pressure or engine oil temperature.

The vehicle 12 further includes suspension components, which may include struts 430, shock absorbers 432, or a combination of such struts and shock absorbers. The struts 430 and shock absorbers 432 may comprise actuatable devices 34 that form part of an active suspension system of the vehicle 12. In accordance with an active suspension system, the struts 430 and shock absorbers 432 may be actuatable to perform known active suspension functions, such as providing vehicle stability control and providing a level ride.

As shown in FIG. 3A, the vehicle 12 may include several systems 10 for sensing condition(s) of the vehicle. The systems 10 may include a steering shaft torque sensing system 450, a steering wheel angle sensing system 470, an engine vibration/knock sensing system 490, an engine oil condition sensing system 510, a fuel tank level sensing system 530, chassis level sensing systems 550, and a vehicle acceleration sensing system 570. As described below, individual systems 10 or combinations of such systems may provide information used to help control actuation of the power assist device 410, indicator lights 424, gauges 426, actuatable struts 430, and actuatable shock absorbers 432.

The systems 10 implemented in the vehicle 12 of FIG. 3A are illustrated in FIGS. 3B-3H. Referring to FIG. 3B, the steering shaft torque sensing system 450 includes a steering shaft torque sensor 452. The steering shaft torque sensor 452 is a known device that may, for example, comprise a strain gauge. The steering shaft torque sensor 452 is operative to sense the torque applied to the steering shaft 406 (FIG. 3A) via the steering wheel 404. The steering shaft torque sensor 452 is operatively connected to a transmitter 454 that provides a wireless signal related to the torque sensed by the steering shaft torque sensor 452. The system 450 also includes an energy harvesting power supply 456.

The energy harvesting power supply 456 includes a piezoelectric energy harvesting material 460 and an energy storage device 462. The piezoelectric energy harvesting material 460 generates electrical energy, which is supplied to the energy storage device 462. The energy storage device 462 supplies electrical energy to the steering shaft torque sensor 452 and transmitter 454.

The steering shaft torque sensing system 450 is connected to a vehicle part 16 (see FIG. 1), specifically the steering shaft 406 (FIG. 3A). The connection is done in a manner such that the piezoelectric energy harvesting material 460 vibrates with the vehicle part 16. For example, the piezoelectric energy harvesting material 460 may be bonded to a substrate, which is bonded to the vehicle part 16. The piezoelectric energy harvesting material 460 generates electrical energy in response to vibrations experienced during operation of the vehicle 12. This electrical energy powers the steering shaft torque sensor 452 and transmitter 454. The steering shaft torque sensing system 450 may thus function without requiring any batteries or external wiring.

Referring to FIG. 3C, the steering wheel angle sensing system 470 includes a steering wheel angle sensor 472. The steering wheel angle sensor 472 is a known device that may, for example, comprise an optical sensor. The steering wheel angle sensor 472 is operative to sense the rotational position of the steering wheel 404 relative to a nominal or straight forward position of the wheel. The steering wheel angle sensor 472 is operatively connected to a transmitter 474 that provides a wireless signal related to the rotational position sensed by the steering wheel angle sensor 472. The system 470 also includes an energy harvesting power supply 476.

The energy harvesting power supply 476 includes a piezoelectric energy harvesting material 480 and an energy storage device 482. The piezoelectric energy harvesting material 480 generates electrical energy, which is supplied to the energy storage device 482. The energy storage device 482 supplies electrical energy to the steering wheel angle sensor 472 and transmitter 474.

The steering wheel angle sensing system 470 is connected to a vehicle part 16 (see FIG. 1), specifically the steering wheel 404 (FIG. 3A). The connection is done in a manner such that the piezoelectric energy harvesting material 480 vibrates with the vehicle part 16. The piezoelectric energy harvesting material 480 generates electrical energy in response to vibrations experienced during operation of the vehicle 12. This electrical energy powers the steering wheel angle sensor 472 and transmitter 474. The steering wheel angle sensing system 470 may thus function without requiring any batteries or external wiring.

Referring to FIG. 3D, the engine vibration/knock sensing system 490 includes a engine vibration/knock sensor 492. The engine vibration/knock sensor 492 is a known device that may, for example, comprise a vibration switch. The engine vibration/knock sensor 492 is operative to sense excessive vibrations or knocking in the engine 420. The engine vibration/knock sensor 492 is operatively connected to a transmitter 494 that provides a wireless signal related to vibration or knocking sensed by the engine vibration/knock sensor 492. The system 490 also includes an energy harvesting power supply 496.

The energy harvesting power supply 496 includes an energy harvesting material 500 and an energy storage device 502. The energy harvesting material 500 may be a piezoelectric or thermoelectric material. The energy harvesting material 500 generates electrical energy, which is supplied to the energy storage device 502. The energy storage device 502 supplies electrical energy to the engine vibration/knock sensor 492 and transmitter 494.

The engine vibration/knock sensing system 490 is connected to a vehicle part 16 (see FIG. 1), specifically the engine 420 (FIG. 3A). For a piezoelectric energy harvesting material 500, the connection is done in a manner such that the energy harvesting material 500 vibrates with the vehicle part 16. The piezoelectric energy harvesting material 500 generates electrical energy in response to engine vibrations experienced during operation of the vehicle 12. This electrical energy powers the engine vibration/knock sensor 492 and transmitter 494. The engine vibration/knock sensing system 490 may thus function without requiring any batteries or external wiring.

Thermoelectric materials can be used to convert thermal energy into electrical energy. The term “thermoelectric” is used broadly to encompass other types of materials capable of converting heat energy into electrical energy, such as thermo-tunneling materials and thermionic materials. Thermoelectric materials, thermo-tunneling materials, and thermionic materials are all known in the art.

For a thermoelectric energy harvesting material 500, the connection is done in a manner such that the energy harvesting material 500 is exposed to heat energy created by the vehicle part 16, i.e., the engine 420. The thermoelectric energy harvesting material 500 generates electrical energy in response to engine heat experienced during operation of the vehicle 12. This electrical energy powers the engine vibration/knock sensor 492 and transmitter 494. The engine vibration/knock sensing system 490 may thus function without requiring any batteries or external wiring.

Referring to FIG. 3E, the engine oil condition sensing system 510 includes a engine oil condition sensor 512. The engine oil condition sensor 512 is a known device that may, for example, comprise a temperature sensor, a pressure sensor, or a fluid level sensor. The engine oil condition sensor 512 may be operative to sense engine oil temperature, engine oil pressure, engine oil level, or a combination of such conditions. The engine oil condition sensor 512 is operatively connected to a transmitter 514 that provides a wireless signal related to engine oil temperature, engine oil pressure, and/or engine oil level sensed by the engine oil condition sensor 512. The system 510 also includes an energy harvesting power supply 516.

The energy harvesting power supply 516 includes an energy harvesting material 520 and an energy storage device 522. The energy harvesting material 520 may be a piezoelectric or thermoelectric material. The energy harvesting material 520 generates electrical energy, which is supplied to the energy storage device 522. The energy storage device 522 supplies electrical energy to the engine oil condition sensor 512 and transmitter 514.

The engine oil condition sensing system 510 is connected to a vehicle part 16 (see FIG. 1), specifically the engine 420 (FIG. 3A). For a piezoelectric energy harvesting material 520, the connection is done in a manner such that the energy harvesting material 520 vibrates with the vehicle part 16. The piezoelectric energy harvesting material 520 generates electrical energy in response to engine vibrations experienced during operation of the vehicle 12. This electrical energy powers the engine oil condition sensor 512 and transmitter 514. The engine oil condition sensing system 510 may thus function without requiring any batteries or external wiring.

For a thermoelectric energy harvesting material 520, the connection is done in a manner such that the energy harvesting material 520 is exposed to heat energy created by the vehicle part 16, i.e., the engine 420. The thermoelectric energy harvesting material 520 generates electrical energy in response to engine heat experienced during operation of the vehicle 12. This electrical energy powers the engine oil condition sensor 512 and transmitter 514. The engine oil condition sensing system 510 may thus function without requiring any batteries or external wiring.

Referring to FIG. 3F, the fuel level sensing system 530 includes a fuel level sensor 532. The fuel level sensor 532 is a known device that is operative to sense the fuel level in the fuel tank 422. The fuel level sensor 532 is operatively connected to a transmitter 534 that provides a wireless signal related to the level sensed by the fuel level sensor 532. The system 530 also includes an energy harvesting power supply 536.

The energy harvesting power supply 536 includes a piezoelectric energy harvesting material 540 and an energy storage device 542. The piezoelectric energy harvesting material 540 generates electrical energy, which is supplied to the energy storage device 542. The energy storage device 542 supplies electrical energy to the fuel level sensor 532 and transmitter 534.

The fuel level sensing system 530 is connected to a vehicle part 16 (see FIG. 1), specifically the fuel tank 422 (FIG. 3A). The connection is done in a manner such that the piezoelectric energy harvesting material 540 vibrates with the vehicle part 16. The piezoelectric energy harvesting material 540 generates electrical energy in response to vibrations experienced during operation of the vehicle 12. This electrical energy powers the fuel level sensor 532 and transmitter 534. The fuel level sensing system 530 may thus function without requiring any batteries or external wiring.

Referring to FIG. 3G, the chassis level sensing system 550 includes a chassis level sensor 552. The chassis level sensor 552 is a known device that is operative to sense the chassis level, i.e., the height of the vehicle chassis relative to a horizontal plane. The chassis level sensor may sense the chassis level, for example, at the struts 430, shock absorbers 432, or both. The chassis level sensor 552 is operatively connected to a transmitter 554 that provides a wireless signal related to the level sensed by the chassis level sensor 552. The system 550 also includes an energy harvesting power supply 556.

The energy harvesting power supply 556 includes a piezoelectric energy harvesting material 560 and an energy storage device 562. The piezoelectric energy harvesting material 560 generates electrical energy, which is supplied to the energy storage device 562. The energy storage device 562 supplies electrical energy to the chassis level sensor 552 and transmitter 554.

The chassis level sensing system 550 is connected to a vehicle part 16 (see FIG. 1), such as the strut 430 or shock absorber 432 (FIG. 3A). The connections are done in a manner such that the piezoelectric energy harvesting material 560 vibrates with the vehicle part 16. The piezoelectric energy harvesting material 560 generates electrical energy in response to vibrations experienced during operation of the vehicle 12. This electrical energy powers the chassis level sensor 552 and transmitter 554. The chassis level sensing system 550 may thus function without requiring any batteries or external wiring.

Referring to FIG. 3H, the vehicle acceleration sensing system 570 includes a vehicle acceleration sensor 572. The vehicle acceleration sensor 572 is a known device, such as an accelerometer, that is operative to sense the vehicle acceleration. The vehicle acceleration sensor 572 is operatively connected to a transmitter 574 that provides a wireless signal related to the acceleration sensed by the vehicle acceleration sensor 572. The system 570 also includes an energy harvesting power supply 576.

The energy harvesting power supply 576 includes a piezoelectric energy harvesting material 580 and an energy storage device 582. The piezoelectric energy harvesting material 580 generates electrical energy, which is supplied to the energy storage device 582. The energy storage device 582 supplies electrical energy to the vehicle acceleration sensor 572 and transmitter 574.

The vehicle acceleration sensing system 570 is connected to a vehicle part 16 (see FIG. 1), such as the vehicle frame (FIG. 3A). The connections are done in a manner such that the piezoelectric energy harvesting material 580 vibrates with the vehicle part 16. The piezoelectric energy harvesting material 580 generates electrical energy in response to vibrations experienced during operation of the vehicle 12. This electrical energy powers the vehicle acceleration sensor 572 and transmitter 574. The vehicle acceleration sensing system 570 may thus function without requiring any batteries or external wiring.

The power assist device 410 is associated with a controller 412, which is associated with a receiver 414. The receiver 414 is operable to receive wireless signals from the various sensing systems 10 of the vehicle 12. The controller 412 is operable to actuate the power assist device 410 in response to the wireless signals received by the receiver 414. For example, the controller 412 may be operable to actuate the power assist device 410 in response to wireless signals received from the steering shaft torque sensing system 450, the steering wheel angle sensing system 470, or a combination of such systems.

The indicator lights 424 and gauges 426 are associated with a controller 427, which is associated with a receiver 428. The receiver 428 is operable to receive wireless signals from the various sensing systems 10 of the vehicle 12. The controller 427 is operable to actuate the indicator lights 424 and gauges 426 in response to the wireless signals received by the receiver 428. For example, the controller 427 may be operable to actuate the indicator lights 424 and gauges 426 in response to wireless signals received from the engine vibration/knock sensing system 490, the engine oil condition sensing system 510, the fuel tank level sensing system 530, or a combination of such systems.

The struts 430 and shock absorbers 432 are associated with a controller 434, which is associated with a receiver 436. The receiver 436 is operable to receive wireless signals from the various sensing systems 10 of the vehicle 12. The controller 434 is operable to actuate the struts 430 and shock absorbers 432 in response to the wireless signals received by the receiver 436. For example, the controller 434 may be operable to actuate the struts 430 and shock absorbers 432 in response to wireless signals received from the steering shaft torque sensing system 450, the steering wheel angle sensing system 470, the chassis level sensing system 550, the vehicle acceleration sensing system 570, or a combination of such systems.

In view of the foregoing, it will be appreciated that the systems 10 for sensing conditions of the vehicle 12 provide wireless signals indicative of sensed vehicle conditions for helping to control the actuation of the power assist device 410, indicator lights 424, gauges 426, struts 430, and shock absorbers 432. The systems 10 are self-powered via energy harvesting devices and thus are battery-free and do not require any external wiring. The systems 10 may, therefore, be installed in the vehicle 12 without having concerns over wiring routes and vehicle wiring harnesses.

As an alternative to the piezoelectric energy harvesting devices of FIGS. 2A-2J and 3B-3H, the systems 10 for sensing conditions of the vehicle 12 may include a magnet-coil energy harvesting device. The magnet-coil device includes a permanent magnet and a coil of conductive material positioned at least partially within the magnetic field of the magnet. The magnet is supported (e.g., via a cantilever beam) for movement relative to the coil and is configured to vibrate with a vehicle part. As the vehicle part and magnet vibrate, an electrical current is induced in the coil. The current may be used to charge a storage device, such as a capacitor. Such a magnet-coil device, for example, may be a microelectromechanical system (MEMS) device.

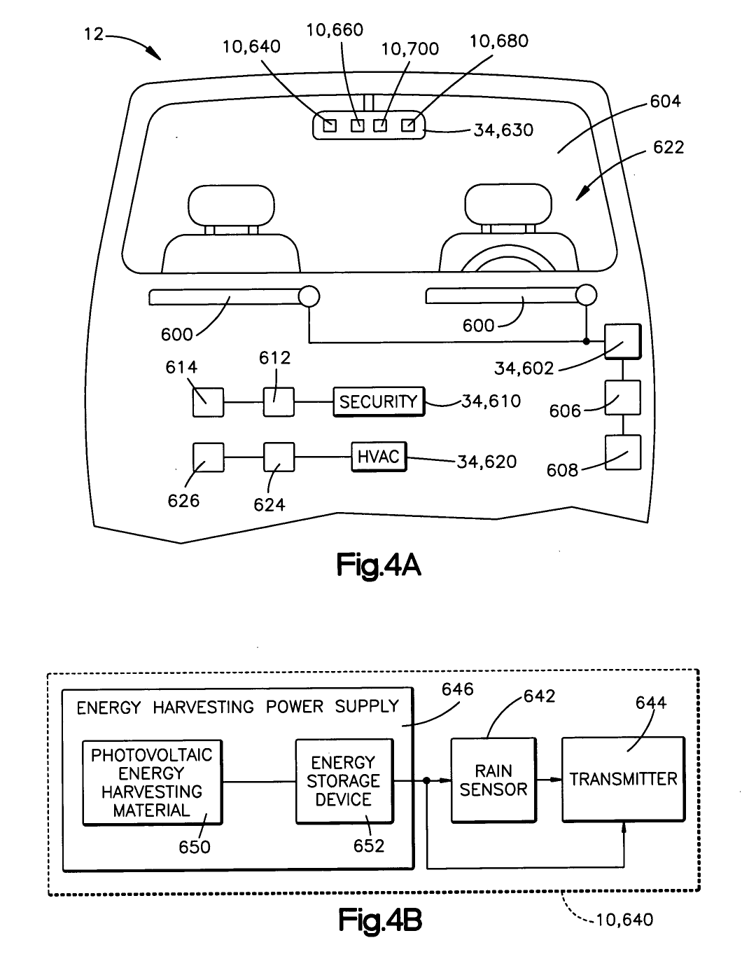

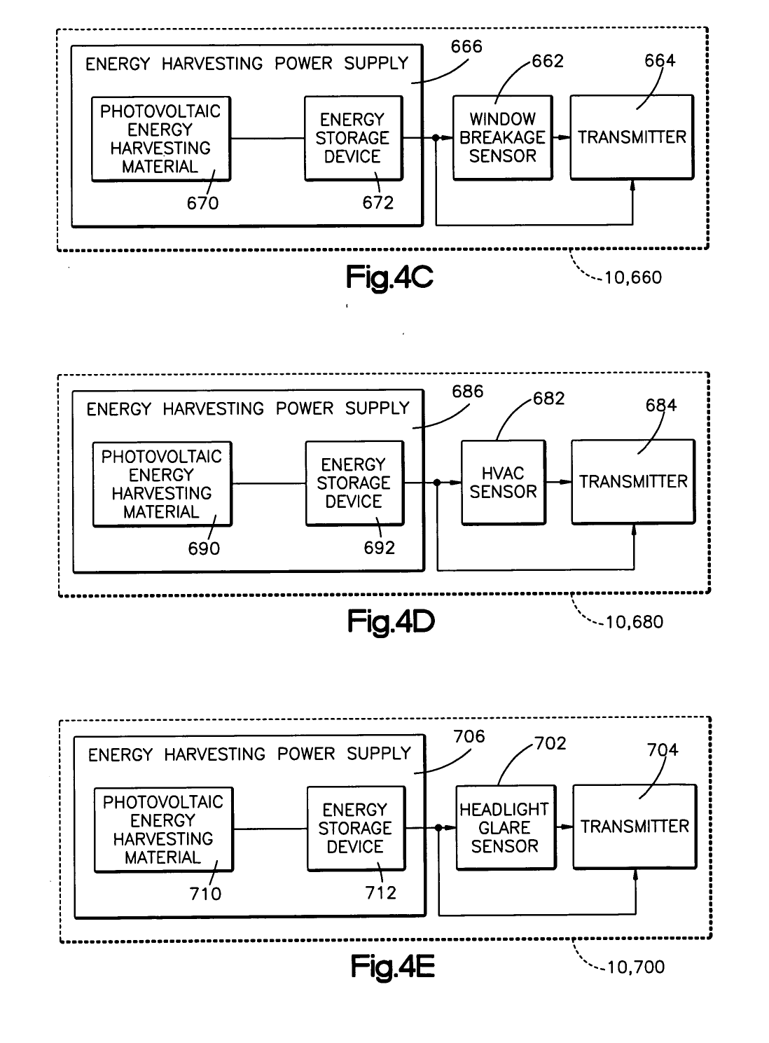

Referring to FIG. 4A, the vehicle 12 may include windshield wipers 600 for wiping rain from a windshield 604 of the vehicle. The windshield wipers 600 are associated with an actuatable device 34, such as a motor 602. The vehicle 12 may also include an actuatable device 34 in the form of a security system 610 for preventing theft or unauthorized use of the vehicle. The vehicle 12 may also include an actuatable device 34 in the form of a heating, ventilation, and air conditioning (HVAC) system 620 for controlling the ambient conditions in a passenger compartment 622 of the vehicle. The vehicle 12 may further include an actuatable device 34 in the form of a rear view mirror 630 with auto dimming features for nighttime driving conditions.

As shown in FIG. 4A, the vehicle 12 may include several systems 10 for sensing condition(s) of the vehicle. In the embodiment illustrated in FIG. 4A, the systems 10 are mounted on the rear view mirror 630. The systems 10 include a rain sensing system 640, a window breakage sensing system 660, an HVAC sensing system 680, and a headlight glare sensing system 700. As described below, the systems 10 may provide information used to help control actuation of the windshield wipers 600, security system 610, HVAC system 620, and rear view mirror 630.

The systems 10 implemented in the vehicle 12 of FIG. 4A are illustrated in FIGS. 4B-4E. Referring to FIG. 4B, the rain sensing system 640 includes a known rain sensor 642. The rain sensor 642 is operative to sense the presence of rain on the windshield 604 (FIG. 4A). The rain sensor 642 is operatively connected to a transmitter 644 that provides a wireless signal related to the rain sensed by the rain sensor 642. The system 640 also includes an energy harvesting power supply 646.

The energy harvesting power supply 646 includes a photovoltaic energy harvesting material 650 and an energy storage device 652. The photovoltaic energy harvesting material 650 generates electrical energy, which is supplied to the energy storage device 652. The energy storage device 652 supplies electrical energy to the rain sensor 642 and transmitter 644.

The rain sensing system 640 is connected to a vehicle part 16 (see FIG. 1), such as the windshield 604 adjacent the rear view mirror 630 (FIG. 4A). The connection is done in a manner such that the photovoltaic energy harvesting material 650 is exposed to solar radiation. The photovoltaic energy harvesting material 650 converts solar energy to electrical energy. This electrical energy powers the rain sensor 642 and transmitter 644. The rain sensing system 640 may thus function without requiring any batteries or external wiring.

The windshield wiper motor 602 is associated with a controller 606, which is associated with a receiver 608. The receiver 608 is operable to receive wireless signals from the rain sensing system 640. The controller 606 is operable to actuate the windshield wiper motor 602 in response to the wireless signals received by the receiver 608 that indicate rain on the windshield 604.

Referring to FIG. 4C, the window breakage sensing system 660 includes a known window breakage sensor 662. The window breakage sensor 662 is operative to sense the presence of window breakage, e.g., breakage of the windshield 604 (FIG. 4A) or other windows (not shown) of the vehicle 12. The window breakage sensor 662 is operatively connected to a transmitter 664 that provides a wireless signal related to any breakage sensed by the window breakage sensor 662. The system 660 also includes an energy harvesting power supply 666.

The energy harvesting power supply 666 includes a photovoltaic energy harvesting material 670 and an energy storage device 672. The photovoltaic energy harvesting material 670 generates electrical energy, which is supplied to the energy storage device 672. The energy storage device 672 supplies electrical energy to the window breakage sensor 662 and transmitter 664.

The window breakage sensing system 660 is connected to a vehicle part 16 (see FIG. 1), specifically the rear view mirror 630 (FIG. 4A). The connection is done in a manner such that the photovoltaic energy harvesting material 670 is exposed to solar radiation. The photovoltaic energy harvesting material 670 converts solar energy to electrical energy, which powers the window breakage sensor 662 and transmitter 664. The window breakage sensing system 660 may thus function without requiring any batteries or external wiring.

The security system 610 is associated with a controller 612, which is associated with a receiver 614. The receiver 614 is operable to receive wireless signals from the window breakage sensing system 660. The controller 612 is operable to actuate the security system 610 in response to the wireless signals received by the receiver 614 that indicate window breakage in the vehicle 12.

Referring to FIG. 4D, the HVAC sensing system 680 includes a known HVAC sensor 682. The HVAC sensor 682 is operative to sense ambient conditions, e.g., temperature, in the passenger compartment 622 of the vehicle 12. The HVAC sensor 682 is operatively connected to a transmitter 684 that provides a wireless signal related to the ambient conditions sensed by the HVAC sensor 682. The system 680 also includes an energy harvesting power supply 686.

The energy harvesting power supply 686 includes a photovoltaic energy harvesting material 690 and an energy storage device 692. The photovoltaic energy harvesting material 690 generates electrical energy, which is supplied to the energy storage device 692. The energy storage device 692 supplies electrical energy to the HVAC sensor 682 and transmitter 684.

The HVAC sensing system 680 is connected to a vehicle part 16 (see FIG. 1), specifically the rear view mirror 630 (FIG. 4A). The connection is done in a manner such that the photovoltaic energy harvesting material 690 is exposed to solar radiation. The photovoltaic energy harvesting material 690 converts solar energy to electrical energy, which powers the HVAC sensor 682 and transmitter 684. The HVAC sensing system 680 may thus function without requiring any batteries or external wiring.

The HVAC system 620 is associated with a controller 624, which is associated with a receiver 626. The receiver 626 is operable to receive wireless signals from the HVAC sensing system 680. The controller 624 is operable to actuate the HVAC system 620 in response to the wireless signals received by the receiver 626 indicative of the ambient conditions in the vehicle 12.

Referring to FIG. 4E, the headlight glare sensing system 700 includes a known headlight glare sensor 702. The headlight glare sensor 702 is operative to sense the presence of headlight glare from vehicles approaching from the rear. The headlight glare sensor 702 is operatively connected to a transmitter 704 that provides a wireless signal related to the headlight glare sensed by the headlight glare sensor 702. The system 700 also includes an energy harvesting power supply 706.

The energy harvesting power supply 706 includes a photovoltaic energy harvesting material 710 and an energy storage device 712. The photovoltaic energy harvesting material 710 generates electrical energy, which is supplied to the energy storage device 712. The energy storage device 712 supplies electrical energy to the headlight glare sensor 702 and transmitter 704.

The headlight glare sensing system 700 is connected to a vehicle part 16 (see FIG. 1), specifically the rear view mirror 604 (FIG. 4A). The connection is done in a manner such that the photovoltaic energy harvesting material 710 is exposed to solar radiation. The photovoltaic energy harvesting material 710 converts solar energy to electrical energy, which powers the headlight glare sensor 702 and transmitter 704. The headlight glare sensing system 700 may thus function without requiring any batteries or external wiring. The presence of headlight glare, sensed by the system 700, may be used to initiate an auto-dimming feature of the rear view mirror 630.

In view of the foregoing, it will be appreciated that the systems 10 for sensing conditions of the vehicle 12 provide wireless signals indicative of sensed vehicle conditions for helping to control the actuation of the windshield wipers 600, security system 610, HVAC system 620, and rear view mirror 630. The systems 10 are self-powered via energy harvesting devices and thus are battery-free and do not require any external wiring. The systems 10 may thus be installed in the vehicle 12 without having concerns over wiring routes and vehicle wiring harnesses.

Other energy harvesting devices 50 may be incorporated with some or all of the systems 10 described herein. One such energy harvesting device 50 that may be incorporated in any of the systems described is a radioactive energy harvesting device. In one such device, a piece of silicon is supported on a cantilever adjacent a low-level radioactive material, such as nickel 63 or tritium. A piece of piezoelectric material is fixed to the cantilever support. As electrons are emitted from the radioactive material, they accumulate on the silicon, causing a negative charge to build. The radioactive material, having a positive charge, attracts the silicon, which causes the cantilever support to bend. As the negative charge increases, the silicon is drawn closer to the radioactive material, until the electrons discharge and the silicon is released to return to its cantilever position. This cycle continues and, as a result, the piezoelectric material is deflected cyclically, i.e., vibrated, and generates an electric current that can be used to charge a device, such as a capacitor. This may be supplemented by vibrations that occur in the vehicle, as described above.

From the above description of the invention, those skilled in the art will perceive improvements, changes and modifications. Such improvements, changes and modifications within the skill of the art are intended to be covered by the appended claims.

Having described the invention, we claim:

1. A system comprising:
an electrical sensor for sensing a condition of a vehicle;
an energy harvesting device for providing electrical energy in response to the vehicle environment, said electrical energy being provided to said electrical sensor; and
a device on the vehicle actuatable in response to the condition of the vehicle sensed by said sensor, said device comprising an inflator for an inflatable vehicle occupant protection device, a seat belt pretensioner, a vehicle chassis control device, a steering power assist device, an indicator light, a gauge, a vehicle security system, a vehicle HVAC system, a rear view mirror anti-glare system, a wiper control system, or an engine condition indication system.

2. The system recited in claim 1, wherein said energy harvesting device produces electrical energy in response to vibration, strain, solar energy, or thermal energy in the vehicle environment.

3. The system recited in claim 2, wherein said energy harvesting device comprises a material for producing electrical energy in response to vibrations or strains in the vehicle environment.

4. The system recited in claim 3, wherein said material is a piezoelectric material.

5. The system recited in claim 3, wherein said sensor comprises a vehicle impact sensor, a vehicle rollover sensor, a seat belt buckle latch sensor, a vehicle acceleration sensor, a vehicle chassis height sensor, a torque sensor, a seat position sensor, a steering wheel angle sensor, a steering wheel torque sensor, or a fuel level sensor.

6. The system recited in claim 2, wherein said energy harvesting device comprises a photovoltaic cell for producing electrical energy in response to solar energy in the vehicle environment.

7. The system recited in claim 6, wherein said sensor comprises a glass breakage sensor, a temperature sensor, a headlight glare sensor, or a rain sensor.

8. The system recited in claim 2, wherein said energy harvesting device comprises a thermoelectric device for producing electrical energy in response to thermal energy in the vehicle environment.

9. The system recited in claim 8, wherein said sensor comprises an engine vibration sensor, and engine knock sensor, an engine oil pressure sensor, an engine oil level sensor, or an engine oil level sensor.

10. The system recited in claim 1, further comprising:
a transmitter for transmitting a wireless signal related to the condition of the vehicle sensed by said sensor;
a receiver for receiving the wireless signal; and
a controller for actuating said device on the vehicle in response to the wireless signal received by the receiver.

11. The system recited in claim 1, wherein said energy harvesting device is mounted to a vehicle part, said energy harvesting device producing electrical energy in response to vibrating or undergoing strain with the vehicle part, in response to being exposed to solar energy on the vehicle part, or in response to being exposed to thermal energy on the vehicle part.

12. The system recited in claim 1, further comprising a capacitive storage device for storing the electrical energy provided by said energy harvesting device and for providing electrical energy to said device on the vehicle.

13. The system recited in claim 1, wherein said energy harvesting device is battery-free.

14. A system comprising:
an electrical sensor for sensing a condition of a vehicle;
an energy harvesting device for providing electrical energy in response to the vehicle environment, said electrical energy being provided to said electrical sensor; and
a device on the vehicle actuatable in response to the condition of the vehicle sensed by said sensor, said energy harvesting device responding to solar or thermal energy of the vehicle environment.

15. The system recited in claim 14, wherein said energy harvesting device comprises a photovoltaic cell for producing electrical energy in response to solar energy in the vehicle environment.

16. The system recited in claim 15, wherein said sensor comprises a glass breakage sensor, a temperature sensor, a headlight glare sensor, or a rain sensor.

17. The system recited in claim 14, wherein said energy harvesting device comprises a thermoelectric or thermo-tunneling device for producing electrical energy in response to thermal energy in the vehicle environment.

18. The system recited in claim 17, wherein said sensor comprises an engine vibration sensor, an engine knock sensor, an engine oil pressure sensor, an engine oil level sensor, or an engine oil level sensor.

19. The system recited in claim 14, further comprising:
a transmitter for transmitting a wireless signal related to the condition of the vehicle sensed by said sensor;
a receiver for receiving the wireless signal; and
a controller for actuating said device on the vehicle in response to the wireless signal received by the receiver.

20. The system recited in claim 14, further comprising a capacitive storage device for storing the electrical energy provided by said energy harvesting device and for providing electrical energy to said device on the vehicle.

21. The system recited in claim 14, wherein said energy harvesting device is battery-free.

22. A system for helping to protect an occupant of a vehicle, said system comprising:
an actuatable vehicle occupant protection device;
an electrical sensor for sensing a condition of the vehicle;
control means for controlling actuation of said vehicle occupant protection device in response to the condition of the vehicle sensed by said sensor;
an energy harvesting device for providing electrical energy in response to the vehicle environment, said electrical energy being provided to said electrical sensor to power said electrical sensor.

23. The system recited in claim 22, further comprising:
a transmitter for transmitting a wireless signal indicative of the condition of the vehicle sensed by said sensor; and
a receiver for receiving the wireless signal and providing a signal indicative the condition of the vehicle sensed by said sensor to said control means.

24. The system recited in claim 23, wherein said sensor is operative to sense a condition of a vehicle part, said sensor, said energy harvesting device, and said transmitter being mounted on the vehicle part.

25. The system recited in claim 24, wherein said receiver and said controller are mounted on the vehicle remotely from the vehicle part.

26. The system recited in claim 22, wherein said receiver and said controller are operatively connected to a power source different than said energy harvesting power source.
